(19) United States
(12) Patent Application Publication
(10) Pub. No.: US 2002/0154984 A1
(43) Pub. Date: Oct. 24, 2002

(54) Modular material shifting device and base element for such a material shifting device

(76) Inventor: Hans Schaeff, Langenburg (DE)

Correspondence Address: SHLESINGER, ARKWRIGHT & GARVEY LLP, 3000 SOUTH EADS STREET, ARLINGTON, VA, 22202, US

(21) Appl. No.: 10/107,544

(22) Filed: Mar. 28, 2002

(30) Foreign Application Priority Data
Mar. 29, 2001 (EP) EP 01 108 089.2

(51) Int. Cl. B66C 3/00

(52) U.S. Cl. 414/729

(57) ABSTRACT

A modular material shifting device with a base element (1) which includes an energy and drive unit (2), with a superstructure (30) which is disposed so as to be rotatable with regard to the base element (1) by means of a ring mount, including a boom system (50) with gripping or holding tool (59) and a counterweight (40) and with a driver's cab assigned to the superstructure (30).

The present invention relates to a modular material shifting device and the base element for such a material shifting device.

Material shifting devices, also called loading or stacking devices, are powerful flexible loading machines with a great operating span of 20 or more meters and rapid working cycles with large grabbers, magnetic plates or similar. Material shifting devices are subjected to different requirements, depending on the type of goods or material which are to be loaded (scrap, wood, rubbish, gravel, sand, etc.) and the place of use (loading and unloading ships, scrap or recycling plant, etc.). Known material shifting devices extend from tracked or wheeled digger-like device via railway-transportable devices up to stationary devices on foundations which are 3 to 6 meters high, or on tubular foundation pylons. Tracked tubular pylon devices are also known.

Hence for example, a material shifting device is known from the prior art which has an especially mobile chassis on which the superstructure with drivers cab, engine bay and boom, by means of a tubular pylon (steel column) is disposed at a height of between 4 and 6 meters. Furthermore, a material shifting device is known from WO 00/51930 A1 wherein the superstructure with the power unit and counterweight is directly connected to the chassis by means of a ring mount, wherein the working apparatus and the driver's cab are disposed on a steel column mounted on the superstructure.

The known material shifting devices are thus based on the basic structure of a digger with a swivellable superstructure, on which the drive and hydraulic unit is disposed together with a co-swivelling ballast weight.

In contrast, according to the invention a modular material shifting device with the features of claim 1 and a base element for such a modular material shifting device with the features of claim 11 is suggested.

A modular material shifting device according to the invention therefore includes a base element in which an energy and drive unit is disposed or integrated, a superstructure which is disposed so as to be rotatable with regard to the base element by means of a ring mount, this superstructure having a boom system with tool (gripping or holding tool such as a grabber, magnet or similar) and a counterweight, and a driver's cab which is assigned to the superstructure. In contrast to the known material shifting devices in the prior art, the energy and drive unit, such as a diesel engine with fuel tank or an electric engine with switching cabinet, as well as hydraulic pump or pumps with hydraulic fluid tank and oil cooling units, is thus not disposed together with the superstructure so as to be swivellable with regard to the chassis, but is disposed in the arrangement according to the invention on, or in, a base element, connected for rotation, as close possible to the ground, wherein a basic construction element (module) is provided on the basis of which a multitude of different material shifting devices can be constructed, according to requirements. Here, the possibilities extend from a stationary device with or without foundations with a wide variety of structure heights to mobile tracked, wheeled or railway shifting devices with a variety of structural heights, which each have a base element, according to the invention, as their basic structural element.

In an advantageous embodiment of the invention, the superstructure is connected directly to the base element by means of a ring mount disposed on the base element. This direct arrangement of the superstructure on the base element provides a material shifting device of low structural height which is especially suitable for mobile use since it can be driven under bridges as a result of its low structural height.

In another advantageous embodiment of the invention, the superstructure is disposed at a distance from the base element via an intermediate element provided between the base element and the superstructure. The intermediate element preferably comprises steel pylons (steel columns) which are available in different heights (or lengths) so that a material shifting device of defined structural height results from suitable selection of an intermediate element dependent on the requirements placed on the material shifting device. In a first preferred embodiment, the intermediate element is disposed rotatably with regard to the base element and connected for rotation with regard to the superstructure. This means that both the intermediate element and the superstructure rotate with regard to the base element which, for example, provides the possibility of disposing the driver's cab on the intermediate element.

In a second preferred embodiment the intermediate element is attached for rotation with the base element, and the superstructure is rotatably disposed between the intermediate element. Hence in this embodiment, it is only the superstructure which rotates with regard to the lower elements, the intermediate element and the base element, which form a unit which are connected for rotation. In this embodiment, the driver's cab is preferably disposed on the superstructure.

In all embodiments the height of the driver's cab can preferably be adjusted, especially lowered. However, it is also possible to configure the driver's cab as a so-called rigid cab, especially on the superstructure, and to provide a ladder via which the driver reaches the driver's cab from the base or the base element.

In a further embodiment of the invention, the counterweight is configured to be fixed or rigid on the superstructure. This configuration is especially preferred for an arrangement without an intermediate element or with only a small intermediate element.

In another embodiment of the invention, the counterweight is configured as an energy store for storing the weight energy of the boom system when the boom system is moved downwards. This configurement is possible when the height at which the superstructure is disposed is greater than the swivelling path of the counterweight which is extended in a swivellable manner for the purpose of energy storage below the lower edge of the superstructure. Hence this configuration is to be preferred in the case of material shifting devices with larger structural height.

The base element according to the invention which forms the basic structural element for the modular material shifting device, according to the invention, includes a central part and an energy and drive unit disposed in the central part, wherein on one upper side of the central part, a cover plate is provided which is configured to selectively accept a ring mount or an intermediate element.

For stationary use, the base element is advantageously supported on a releasably-mounted base sub-construction which increases the surface area of the base element and which preferably comprises base and/or support plates. Advantageously, the base sub-construction has two solid and two releasable supporting plates, wherein the ground or supporting plates on the one hand are configured to be so large that they correspond to the load capacity of the foundations and on the other hand are so heavy or thick that they provide enough security from tipping for the working device.

For mobile use the base element advantageously has releasably-mounted transverse supports (in place of the base sub-construction profiles of the stationary base) for mounting a chassis, especially a tracked or a rail-transported chassis, or a releasably-mounted wheeled chassis, or one which is integrated in the base, preferably with releasably-mounted supporting apparatus.

Advantageously, the flange and screw connections for releasable attachment of the base sub-construction or chassis elements are configured and normalised in such a way that the different elements can be exchangeably mounted on the same connection elements of the base element.

Other advantages and configurations of the invention result from the description and the enclosed drawings.

It is understood that the aforementioned features, and those which are still to be explained in the following text, can not only be used in the given combinations but also in other combinations or on their own without leaving the framework of the present invention.

The invention is schematically shown in the drawings with reference to a number of embodiment examples, and is described in detail in the following text with reference to the drawings.

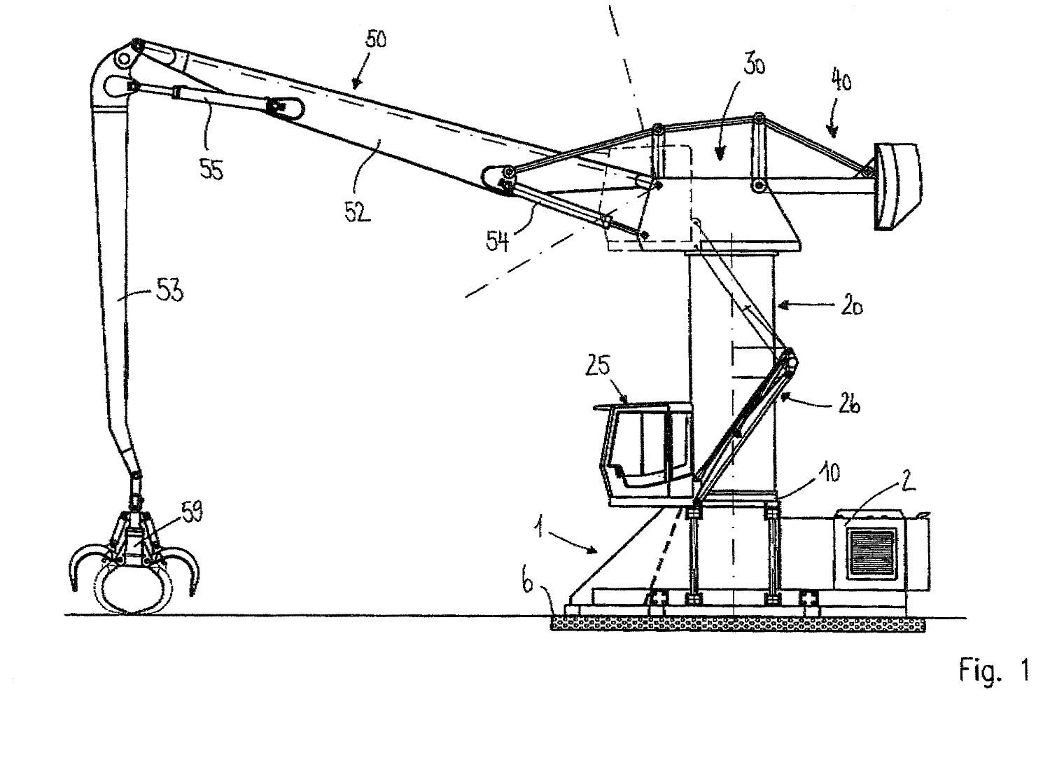

FIG. 1 shows a modular material shifting device, according to the invention, with swivellable counterweight for stationary use.

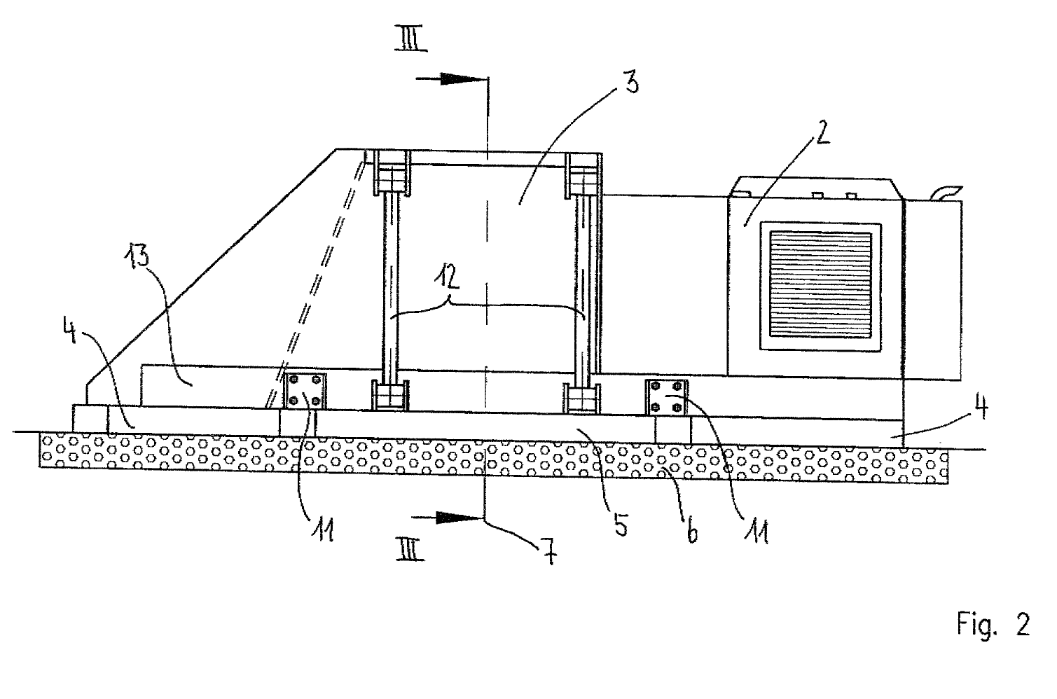

FIG. 2 shows the base element of the material shifting device of FIG. 1.

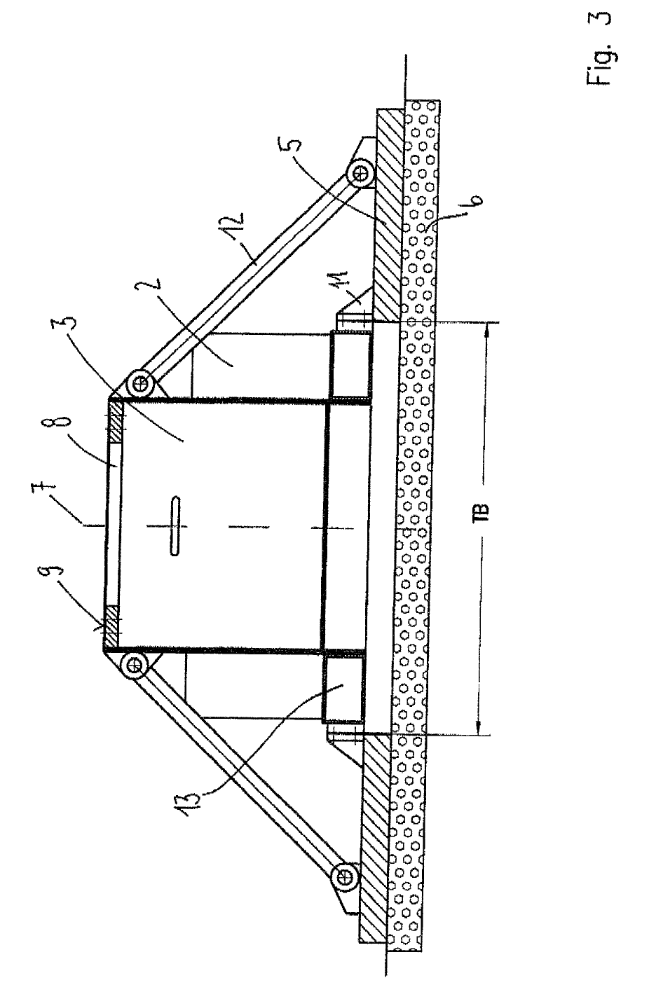

FIG. 3 shows the base element of FIG. 2 according to cross-sectional line III-III.

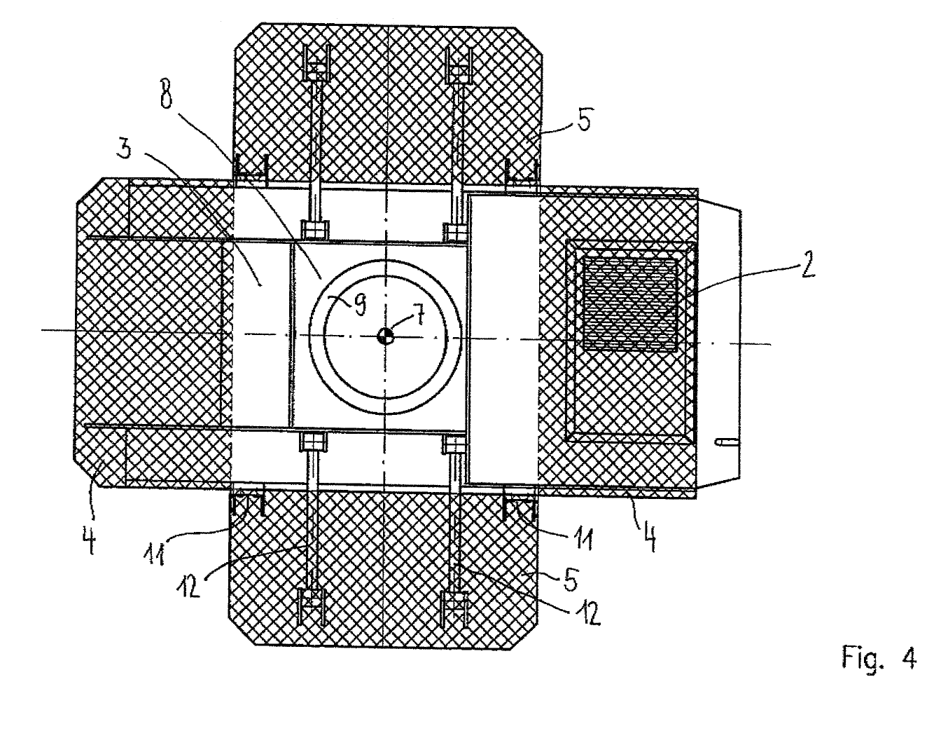

FIG. 4 shows a top elevation of the base element of FIG. 2.

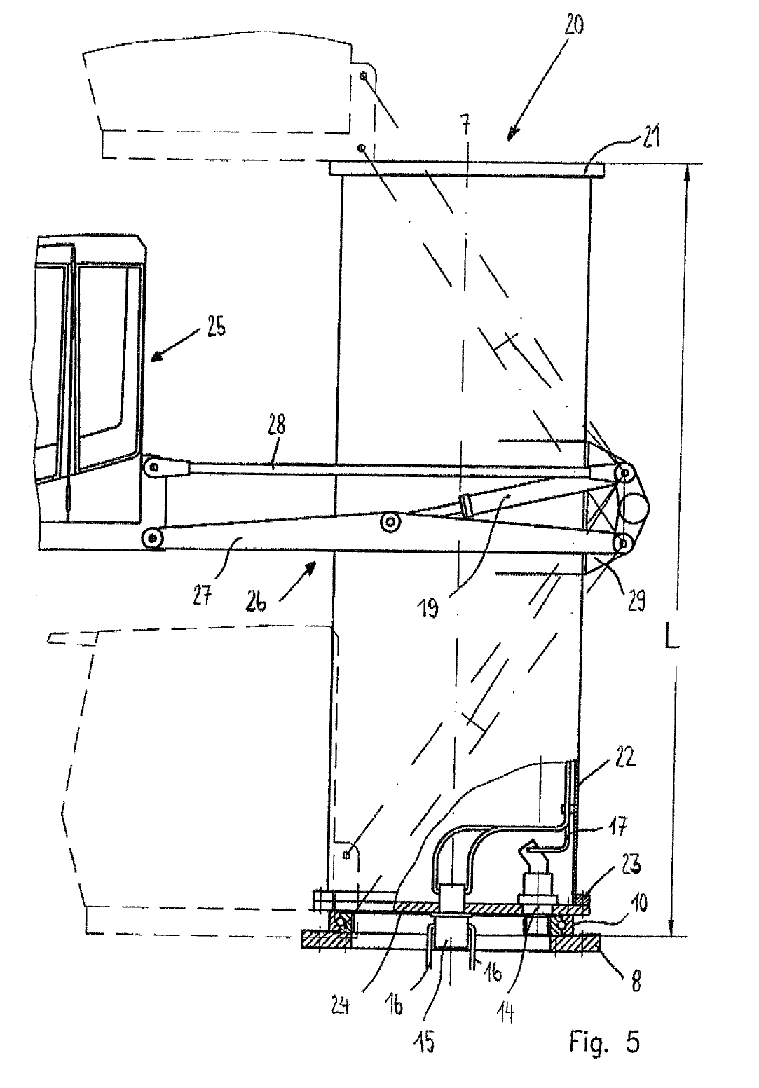

FIG. 5 shows an increased-scale sectional representation of the arrangement of the intermediate element on a ring mount of the base element and arrangement of the driver's cab on the intermediate element.

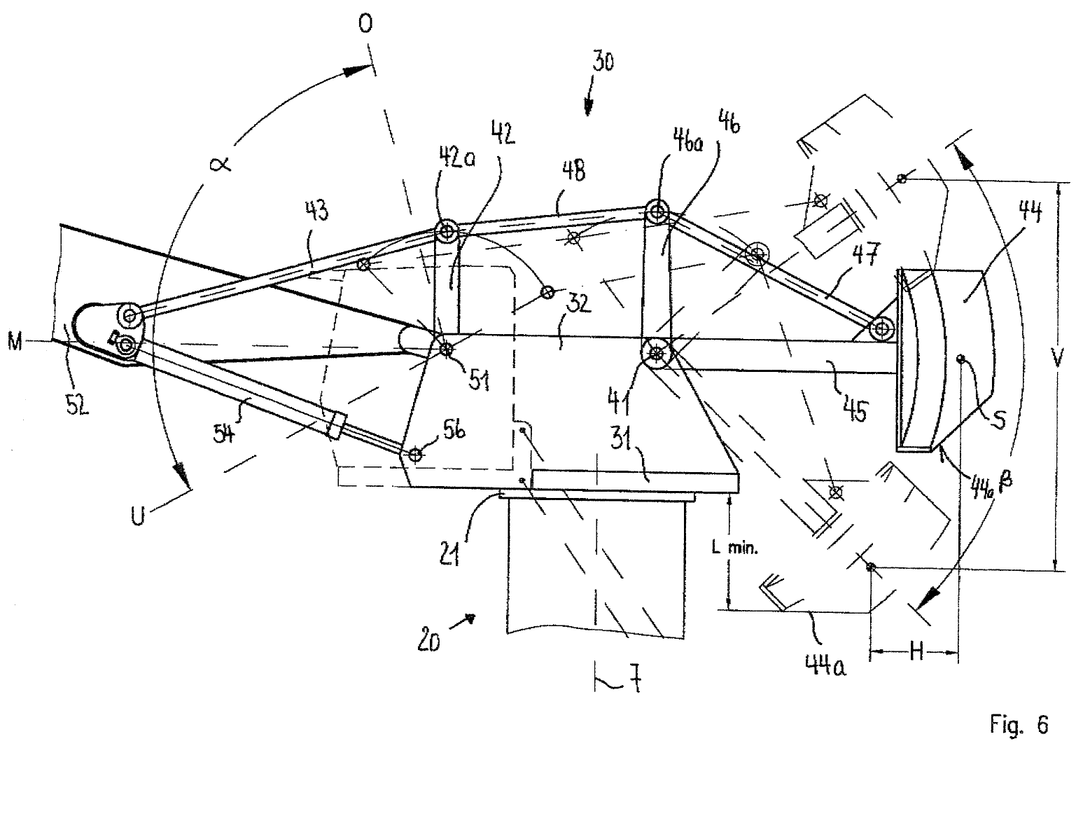

FIG. 6 shows an increased-scale sectional representation of the functionality of the swivellable counterweight of the material shifting device of FIG. 1.

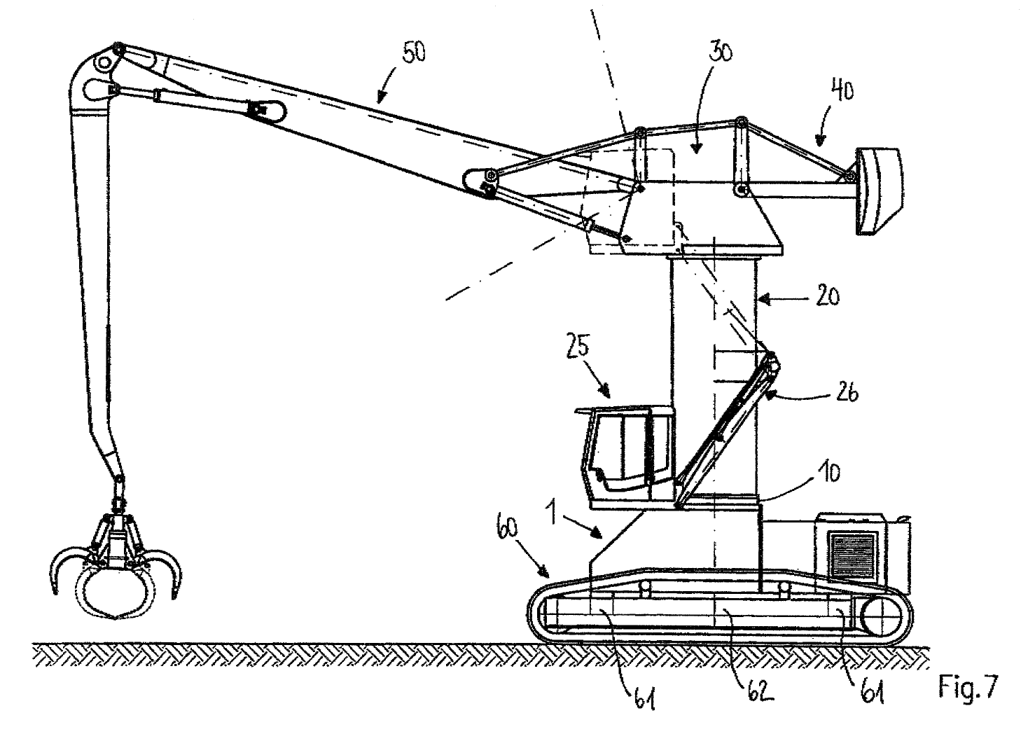

FIG. 7 shows, as a further embodiment example, a material shifting device, similar to the material shifting device of FIG. 1, with tracked chassis for mobile use.

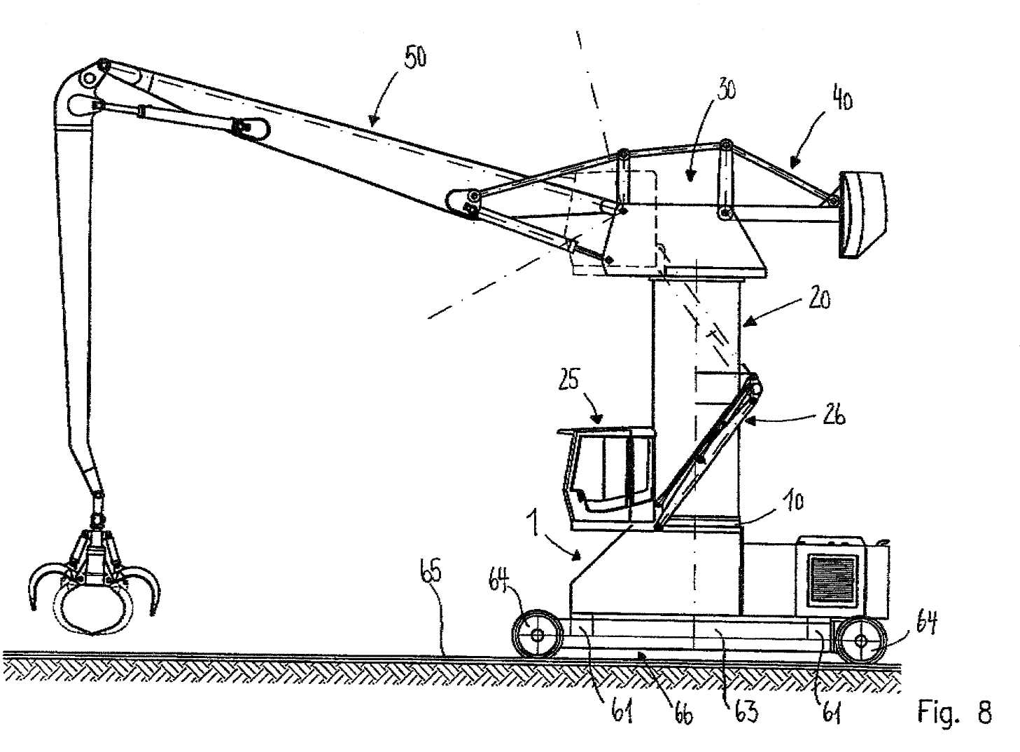

FIG. 8 shows the material shifting device of FIG. 7 with rail-mounted chassis.

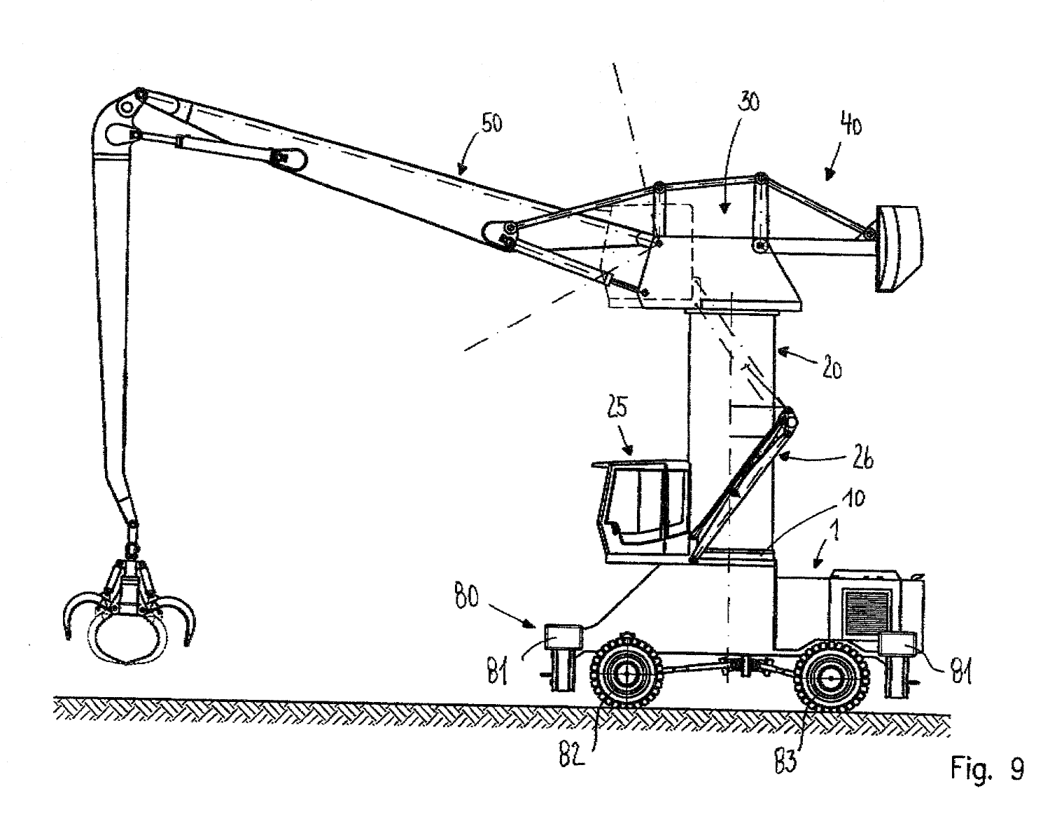

FIG. 9 shows the material shifting device of FIG. 7 with wheeled chassis.

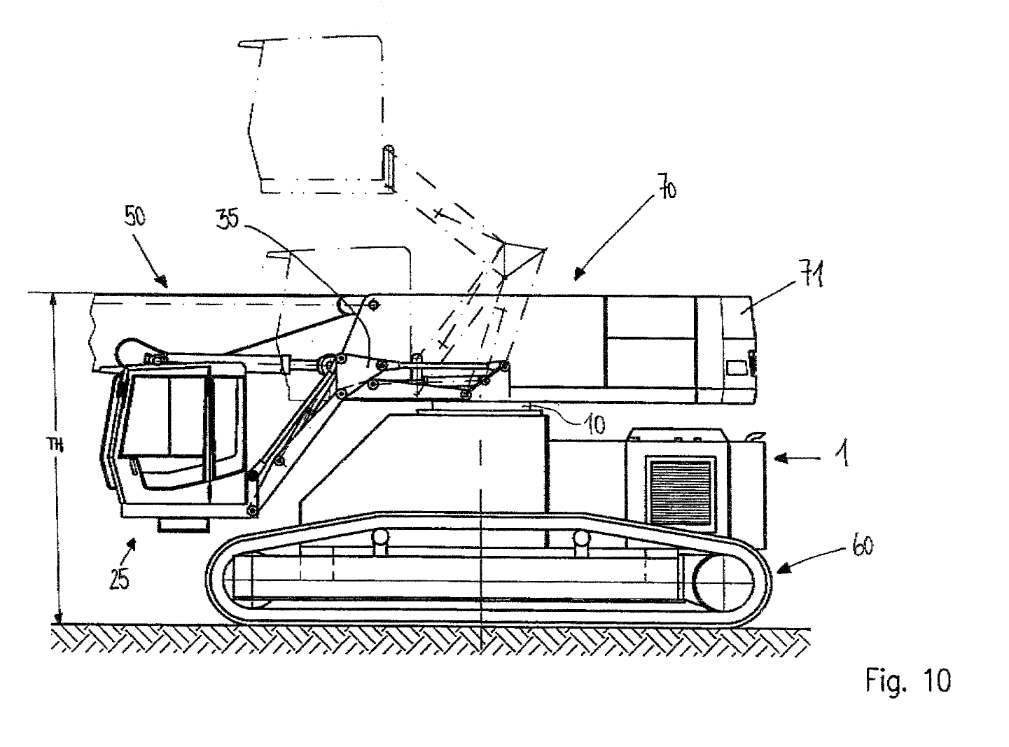

FIG. 10 shows, as a sectional representation in lateral elevation, a further embodiment example of a material shifting device, according to the invention, with tracked chassis and superstructure mounted directly on the base element.

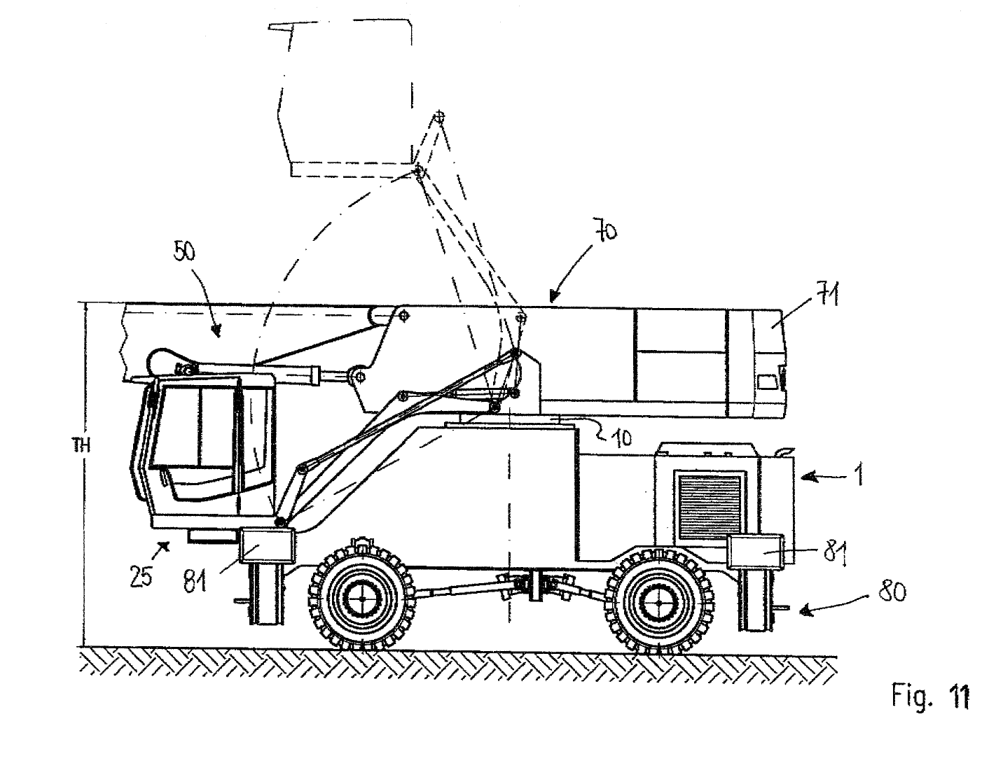

FIG. 11 shows, as a further embodiment example, a material shifting device similar to the material shifting device of FIG. 10 with wheeled chassis and alternative embodiment of the lifting driver's cab.

FIG. 1 shows, in lateral elevation, a first embodiment example of a modular material shifting device, according to the invention, with a base element 1, a superstructure 30 with boom system 50 and energy storage plant (swivellable counterweight) 40 and an intermediate element 20 disposed between the base element 1 and the superstructure 30. FIG. 2 shows, in lateral elevation of increased-scale, the base element 1 of FIG. 1 and FIG. 3 shows a cross-section through the base element of FIG. 2 along the cross-section line III-III.

The base element 1 comprises a central part 3 and an energy and drive unit 2 disposed adjacent to the central part 3, supported by a base sub-construction. The base sub-construction comprises bed plates 4 and supporting plates 5 (cf. also FIG. 4). The bed plates 4 and supporting plates 5 are again disposed on a base plate 6. The base plate 6 advantageously comprises normal industrial flooring, such as e.g. a concrete plate approximately 15 cm thick or concrete building blocks or similar laid in sand. A tar coating is not suitable for the base plate 6 since the tar softens when heated by the sun's rays and the material shifting device may shift into a position which is not ideal.

In the represented embodiment example the supporting plates 5 are attached to longitudinal support profiles 13 disposed along the base element or are attached to the central part 3 (flanged on) by means of screw brackets 11 and supporting rods 12. As can especially be seen from FIG. 4 (in which the bed plates 4 and supporting plates 5 are shown shaded with crosshatching), the bed and supporting plates increase the surface area of standing surface of the base element. For transportation purposes, the supporting plates 5 are removed by releasing the flanged connections to the longitudinal supporting profiles 13 or to the central part 3, so that the base element has a transportation width TB. The supporting plates are attached (again) upon reaching the location of the deployment. These supporting plates are, for example, common commercial rough metal plates. In the shown embodiment example, the dimensions of the plates are 3×1.5×0.2 m, the standing surface (corresponding to the cross-hatched shaded surfaces in FIG. 4) is 4×3×1.5=18 m², wherein the base element is set up on a base surface of 6×6 m².

A cover plate 8 is provided on the top side of the base element, the upper side 9 of which is mechanically worked and drilled in such a way that it is suitable for accepting a ring mount 10 (cf. FIGS. 1 and 5) or for direct attachment to the intermediate element 20. In the embodiment example shown in FIG. 1, a ring mount 10 is disposed on the base element 1 on which again the intermediate element 20 is disposed. The intermediate element 20 is connected for rotation with the superstructure 30 at its upper end. A lifting driver's cab 25 is attached by means of a parallel arm lifting mechanism 26, which is known per se, approximately half way up the height of the intermediate element 20. Both the rotary connection of the intermediate element 20 to the cover plate 8 of the base element 1 and also the attachment of the lifting driver's cab 25 to the intermediate element 20 can be seen in the increased-scale sectional representation of FIG. 5.

A console 29 is attached approximately halfway up the intermediate element 20, the intermediate element having a height L, for attachment of the lifting driver's cab 25. A lifting arm 27 and a parallel guiding rod 28 are attached to the console, these being attached with the other ends to a base of the lifting driver's cab 25 in such a way that they extend parallel to one another. A lifting cylinder 19 is disposed between the lifting arm 27 and the console 29. When the lifting cylinder 19 is operated (retraction or extension of the cylinder), the lifting driver's cab 25 is swung out of the horizontal position represented in FIG. 5 into the upper or lower position (shown in dotted lines). This adjustability of the lifting driver's cab allows the driver to gain access to the lifting driver's cab 25 in its lowered position without a ladder or with only a small ladder, and then the cab can be swivelled into an upper working position. Furthermore, the driver can adapt his working height during operation of the material shifting device by swivelling the lifting driver's cab 25 according to requirements. With different heights of the utilised intermediate element, the lengths of the lifting arms 27 and the parallel guiding rods 28 must be adapted to suit.

As can also be seen from FIG. 5, the intermediate element 20 comprises a steel pipe 22 with upper flange 21 and base flange 23. An intermediate flange 24 is provided for attachment of the intermediate element 20 to the ring mount 10, which is flanged onto the cover plate 8 of the base element 1, this intermediate flange on the one hand being attached by screwing to a non-toothed part of the ring mount 10 and on the other hand with the base flange 23 of the intermediate element 20. Furthermore, a swivelling drive 14 and a hydraulic rotary transmission 15 are mounted on the intermediate flange 24. If the superstructure is mounted directly on the base element (cf. FIGS. 10 and 11), the intermediate flange 24 corresponds to a superstructure bed plate 31. Hydraulic lines 16 starting from a pump unit disposed in the base element 1 are guided through a non-rotating part (stator) of the rotary transmission in a rotational axis 7 of the ring mount 10 and these leave the rotational transmission 15 in the rotating part (rotor) so that they may be guided further in the interior of the steel pipe 22 to control units in the superstructure 30. Hydraulic lines 17 from the control unit disposed in the superstructure are guided to the swivel drive 14.

Naturally, other embodiments and versions of the arrangement of the intermediate element and the superstructure are also possible. For example, the base flange 23 of the intermediate element 20 can be screwed directly to the cover plate 8 of the base element 1 and the ring mount, along with its drive and rotary transmission, can be attached to the bed plate of the superstructure. This leads to an embodiment with rigid, i.e. non-rotating intermediate element 20, wherein—as already mentioned—the lifting driver's cab 25 shown in FIGS. 1 and 5 cannot be used. With this embodiment, the lifting driver's cab must be attached to the superstructure, or an embodiment with a cab attached rigidly to the superstructure and with a ladder is used.

The superstructure 30 of the material shifting device shown in FIG. 1 includes the aforementioned boom system which comprises a main boom 52, a boom jib 53 and a grabbing tool 59 disposed at the end of the boom jib 53. The boom jib 53 is pivoted on the boom arm 52 and can be adjusted by means of a jib cylinder 55. The main boom 52 is pivoted on a boom bearing 51 on the superstructure 30 and can be adjusted by means of one or two boom cylinders disposed between the main boom 52 and the superstructure 30.

As already described, the superstructure 30 is screwed by its bed plate 31 to the upper flange 21 of the rotatable intermediate element 20. A welded construction 32 is built up on the bed plate 31 on which the boom system 50 and the swivellable counterweight 40 are pivoted.

In FIGS. 1 and 6, the main boom 52 is shown in that position where, together with the boom jib 3, it can attain the greatest extent (median line position M). This median line position M thus corresponds to the greatest load moment (rotating to the left). The two boom end positions, which span an angle γ, are characterised, using dotted lines, by a median line O for the upper end position and a median line U for the lower end position.

The energy storage system (swivellable counterweight) comprises a swivelling weight 44 which is attached to a swivelling weight bearing 41 of the welded construction 32 of the chassis 30 by means of a weight swinging arm 45. Furthermore, the swivelling weight 44 is connected to the main boom 52 by means of a lever-rod construction 42, 43, 46, 47, 48 in such a way that when the main boom 52 is lowered, the swivelling weight 44 is lifted (for energy storage) and is lowered when the main boom 52 is raised.

In addition, a boom lever 42 is attached to the boom bearing 51 and is connected to the main boom 52 by means of a boom torsion rod 43. Furthermore, a weight swivelling lever 46 is attached to the swivelling weight bearing 41 and is connected to the swivelling weight 44 by means of a swivelling weight torsion rod 47. A connection torsion rod 48 connects the boom lever 42 with the weight swivelling lever 46 between attachment points 42a and 46a. Naturally, this configuration is only one of many which are possible. For example, the main boom 52 could also be configured so that the attachment point 42a is a part of the main boom. The decisive factor is that transmission of the swivelling movement of the main boom 52 to the swivelling weight 44 disposed opposite on the superstructure 30 takes place with the lever-rod arrangement.

In order to keep the maximum swivelling angle β of the swivelling weight 44 smaller than the boom swivelling angle α, the weight swivelling lever 46 is 20% larger than the counter-lever (boom lever 42) in the illustrated embodiment example.

The connection torsion rod 48 which connects the two levers 42, 46 provides energy equilibration between the upward- and downward-swinging boom system (in the left of the diagram) and the opposed upward- and downward-moving swivelling weight 44 (shown on the right in the diagram). The centre of gravity of the swivelling weight 44 is shown with S and the maximum vertical travel of the centre of gravity is shown with the letter V. The centre of gravity S of the swivelling weight 44 also moves in the horizontal direction, this travel is shown with H. The swivelling weight 44 is at its greatest distance from the rotational axis 7 when the boom system 50 can attain its greatest distance, i.e. extent, from the rotational axis 7.

If one ignores the boom jib 53 with the grabbing tool 59 (and the variable loaded material) and only considers the main boom 52 in an exchange cycle with the swivelling weight 44 or the assumed centres of gravity of the main boom 52 and the drive cylinders 54 and 55 on the one hand and the centre of gravity S of the swivelling weight 44 on the other side, the left- and right-rotating moments resulting from the boom/cylinder centre of gravity times the centre-to-centre spacing rotating to the left around the boom bearing 51 and the counterweight centre of gravity S times the centre-to-centre spacing around the swivelling weight bearing 41 extensively cancel each other so that the boom-cylinder 54 and 55 must only move the changing loads from the boom jib and the grabber and the load, without the dead weight of the main boom.

In order to be able to use the swivelling weight system, according to the invention, with very short intermediate elements 20, a lower section of the swivelling weight 44 at 44a is advantageously configured and flattened off so that in its lowest position it is substantially cut off horizontally so that an intermediate piece 20 with a length of Lₘᵢₙ can be used.

FIGS. 7 to 11 show driveable/mobile embodiment examples of a material shifting device according to the invention. FIG. 7 shows a material shifting device whose structure substantially corresponds to that of the material shifting device shown in FIG. 1, with the difference that the base element 1 has a tracked chassis 60 in place of the base sub-construction described in connection with FIGS. 1 and 2. To this end, two transverse members 61 are provided on the base element 1 in place of the base sub-construction of bed and supporting plates and longitudinal support profiles 13, these transverse members supporting the base element 1 and two tracks 62 with hydraulic drive. The axial distance between the leading wheel and the tumbler corresponds approximately to the length of the base element shown in FIG. 1. Since the tracks may not be used on the road, the distance between the two tracks 62 is wide enough to give sufficient transverse stability. The base element and the tracked chassis are thus connected together at their place of use.

FIG. 8 shows a material shifting device whose structure substantially corresponds to that of the material shifting device shown in FIG. 7, with the difference that a rail chassis 66 is attached to the transverse member 61. The railway chassis substantially comprises two longitudinal support 63 which support two free-spinning and two driven bogie wheels 64 via which the material shifting device can be driven on rails 65. Track gauge and wheel base of the bogie wheels are selected so that sufficient stability is guaranteed.

FIG. 9 shows the material shifting device of FIGS. 7 and 8 with a wheeled chassis 80. The wheeled chassis is built below or in the base element 1 in place of the hereinbefore-described base sub-construction, and includes support apparatus 81 and usually a steering axle and a rigid axle 83. Two steering axles can also be used. When the vehicle is being driven, the supporting apparatus 81 is swivelled upwards and the boom system 50 must be aligned along the longitudinal direction of the chassis—as shown in FIG. 9. During operation, the supporting apparatus 81 must be lowered to guarantee stability.

FIG. 10 shows a derivation of the material shifting device, according to the invention, with tracked chassis, wherein a superstructure 70 is connected directly to the ring mount 10 of the base element 1. In contrast to the hereinbefore-described superstructure 30, the superstructure 70 has a fixed counterweight 71 and a lifting cab with per se known double arm lifting mechanism 35 which can be lowered for driving the material shifting device under bridges and for comfortable access of the driver. The kinematics of the illustrated lifting cab are known, for example, from DE 44 43 170 C2. When the lifting cab is lowered and when the boom system is folded for transportation, a transportation height TH of approximately 4 to 4.2 m can be attained, which corresponds to the head room of road bridges.

FIG. 11 shows a further embodiment example of the material shifting device according to the invention with wheeled chassis and superstructure 70 disposed directly on the base element 1, comparable to the configuration shown in FIG. 10, wherein an alternative lifting mechanism is provided for the lifting cab 25.

Diesel-operated material shifting devices are shown in all described figures. Primarily stationary devices (FIG. 1) and devices which can be transported by rail (FIG. 8) are often also electric-powered. Here, the combustion engine which powers the hydraulics is replaced by an electric motor and the space which becomes free when the fuel tank is removed can be used for electrical fuses and switches. In the case of the embodiment example represented in FIG. 8, which can be transported by rail, a cable drum is built onto the base element.

Hence according to the invention, a modular and variable material shifting device is provided wherein no drive and pump units are provided on the superstructure which is why from a certain length of intermediate element the counterweight necessary for stability on the superstructure can be used as an energy store in order to partially compensate for the lifting and breaking energy required for moving the boom.

1. A modular material shifting device with a base element (1) which includes an energy and drive unit (2), with a superstructure (30, 70) which is disposed so as to be rotatable with regard to the base element (1) by means of a ring mount, this superstructure including a boom system (50) with gripping or holding tool (59) and a counterweight (40, 44; 71) and with a driver's cab assigned to the superstructure (30, 70).

2. A material shifting device according to claim 1, wherein the superstructure (70) is connected directly to the base element (1) via a ring mount (10) disposed on the base element (1).

3. A material shifting device according to claim 1, wherein the superstructure (30) is disposed at a distance from the base element via an intermediate element (20) between the base element (1) and the superstructure (30).

4. A material shifting device according to claim 3, wherein the intermediate element (20) is disposed so as to be rotatable with regard to the base element (1) and is connected for rotation with the superstructure (30).

5. A material shifting device according to claim 3, wherein the intermediate element (20) is connected for rotation with regard to the base element (1) and the superstructure (30) is disposed so as to be rotatable with regard to the intermediate element (20).

6. A material shifting device according to one of claims 1 to 5, wherein the driver's cab (25) is disposed on the superstructure (30, 70).

7. A material shifting device according to claim 4, wherein the driver's cab (25) is disposed on the intermediate element (20).

8. A material shifting device according to one of claims 1 to 7, wherein the height of the driver's cab can be adjusted, in particular lowered.

9. A material shifting device according to one of claims 1 to 8, wherein the counterweight (71) is fixed or rigid.

10. A material shifting device according to claim 3, wherein the counterweight (40, 44) is configured as an energy store for storing the weight energy of the boom system (50) when the boom system (50) is lowered.

11. A base element for a modular material shifting device according to one of claims 1 to 10, including a central part (3) and an energy and drive unit (2) disposed on the central part (3), or at least partially integrated into the central part (3), wherein a cover plate (8) is provided on an upper side of the central part (3) which is configured to selectively accept a ring mount (10) or an intermediate element (20).

12. A base element according to claim 11, on which a base sub-construction which increases the bed or standing surface of the base element (1) can be releasably mounted for stationary use.

13. A base element according to claim 12, wherein the base sub-construction comprises two fixed supporting plates (4) and two releasable supporting plates (5).

14. A base element according to claim 11, on which transverse members (61) can be releasably mounted for disposal of a chassis (60, 66), in particular a tracked or rail-transported chassis, for mobile use.

15. A base element according to claim 11, on which a wheeled chassis with supporting apparatus is integrated into the base construction for mobile use.
